(19) United States
(12) Patent Application Publication
(10) Pub. No.: US 2004/0206856 A1
(43) Pub. Date: Oct. 21, 2004

(54) Adapter bracket for use with a gas igniter

(76) Inventors: Jose Cordero, Moca, PR (US); Miguel A. Rodriguez, Cabo Rojo, PR (US); George C. Hanna, Chagrin Falls, OH (US)

Correspondence Address: Robert V. Vickers, Fay, Sharpe, Fagan, Minnich & McKee, LLP, 7th Floor, 1100 Superior Avenue, Cleveland, OH, 44114-2518, US

(21) Appl. No.: 10/417,295

(22) Filed: Apr. 16, 2003

(51) Int. Cl. F16L 3/08

(52) U.S. Cl. 248/70

(57) ABSTRACT

An adapter bracket for securing a gas igniter to a support surface. The gas igniter having an axis and including a cylindrical outer surface having an outer diameter. The adapter bracket being formed by a bracket body extending in a longitudinal direction between a first end and a second end wherein the bracket body is curved about a clip axis transverse to the longitudinal direction thereby forming a clip portion near the first end of the body. The clip portion being shaped to receive the cylindrical outer surface of a gas igniter having an opening sized smaller than the outer diameter of the igniter outer surface to retain the gas igniter relative to the bracket such that the igniter axis is parallel to the clip axis. The bracket body further including a slot near the second end which extends at a slot angle from the longitudinal direction wherein the slot angle is between 45° and 90°.

This invention relates to the art of brackets for supporting a gas igniter and, more particularly, to an adapter bracket for supporting a gas igniter relative to a support surface.

### BACKGROUND OF THE INVENTION

It is, of course, well known that a gas igniter can be used to ignite a flammable gas for use in connection with all types of heating applications. Further, it is well known that the gas igniter must be supported relative to a support surface in the heating apparatus so that the gas igniter is spaced from the support surface and properly oriented relative to the gas flow. The present invention is particularly applicable for use in connection with heating applications and, therefore, the invention will be discussed with particular reference to a heating application. However, the invention has broader applications and may be used with any type of appliance and/or heating apparatus which utilizes a gas igniter.

In order to support the gas igniter, a bracket must be utilized which can be securely fastened to the gas igniter without damaging the gas igniter and which can be securely fastened to a support surface in the heating apparatus. Further, the bracket must be capable of withstanding the environments in which the gas igniter is to be used. In this respect, gas igniters are used to ignite a flammable gas which in turn is used to provide the heat for the heating apparatus. As a result, the gas igniter and support bracket are subjected to high temperatures produced by the burning gas. In addition, during the function of igniting the gas and the operation of the heating apparatus, the gas igniter and bracket are subjected to vibrations. Therefore it is beneficial if the bracket is capable of withstanding and absorbing shock while maintaining the proper orientation of the igniting element of the gas igniter. Furthermore, due to the adverse conditions in which the igniter and brackets are used, it is also beneficial if the bracket is made from a material resistant to corrosion.

While prior art gas igniter brackets are designed to adequately maintain a gas igniter in an operating position, many differently configured prior art brackets are required to handle the many different heating applications. In this respect, while prior art bracket are capable of holding the igniting element of the igniter in the proper orientation relative to the flow of flammable gas, they are limited to a particular gas igniter and a particular heating apparatus. The many configurations of gas igniters and the many heating apparatuses have necessitated the use of many differently configured brackets for use in each of the particular applications. This results in high inventory costs to maintain proper inventory of the many different brackets needed for the different applications and also higher installation costs especially when the needed bracket configuration is not available to the worker installing the gas igniter. Furthermore, prior art brackets do not sufficiently absorb vibrations produced by the heating apparatus thereby reducing the life expectancy of the gas igniter.

### SUMMARY OF THE INVENTION

In accordance with the present invention, provided is an adapter bracket which can be used in connection with several gas igniters to securely mount the gas igniter onto a wide range of support surfaces. In this respect, an adapter bracket in accordance with the present invention includes a bracket body having a flexible clip portion on one end which can clip onto an outer cylindrical surface of several different types of gas igniters and an angled slot on the other end which allows the adapter bracket to be securely fastened to a wide range of support surfaces. By utilizing the flexible clip portion along with the angled slot configuration, the adapter bracket according to the present invention can be used in connection with many applications without necessitating the inventory of many differently configured brackets. Furthermore, an adapter bracket according to the present invention can be used in connection with a pre-bracketed gas igniters when the preassembled bracket cannot be used with a particular application. This further reduces inventory costs and reduces the likelihood that the installer will need to wait for a specific bracket.

Another aspect of the present invention is that the angled slot is part of a mounting leg which further includes a downwardly extending flange which helps prevent rotation of the adapter brackets about the fastener and relative to the mounting surface.

Yet another aspect of the present invention is that the bracket body further includes a connecting leg between the flexible clip and the mounting leg which extends upwardly from the mounting leg so that the clip portion and gas igniter are spaced from the heating apparatus. In addition, the bracket body can further be made from a shock resistant material so that the connecting leg acts as a shock absorber to absorb any shock and/or vibrations produced by the heating apparatus and the function of the gas igniter thereby increasing the useful life of the gas igniter system.

Even yet another aspect of the present invention, the bracket body can be made from a non-corrosive material to further increase the useful life of the bracket.

The primary object of the present invention is the provision of an adapter bracket which can be used in connection with a wide range of gas igniters and a wide range of heating apparatuses so that one bracket can take the place of several supporting brackets.

Another object is the provision of an adapter bracket of the foregoing character that can maintain the igniting element of the gas igniter in an operating position even under severe conditions.

Still another object is the provision of an adapter bracket of the foregoing character that can be easily secured to the gas igniter and to the support surface.

A further object is the provision of an adapter bracket of the foregoing character which has shock absorbing characteristics.

Yet a further object is the provision of an adapter bracket of the foregoing character which can be used in connection with pre-bracketed gas igniters to allow the pre-bracketed igniters to be used with a wider range of heating applications.

Another object is the provision of an adapter bracket of the foregoing character which is economical to manufacture, easy to use in the field and which securely retains the gas igniter in an operating position.

### BRIEF DESCRIPTION OF THE DRAWINGS

The foregoing objects, and others, will in part be obvious and in part be pointed out more fully hereinafter in conjunction with a written description of a preferred embodiment of the present invention illustrated in the accompanying drawings in which:

FIG. 1 is a perspective view of an adapter bracket in accordance with the present invention;

FIG. 2 is a partially exploded perspective view of the adapter bracket shown in FIG. 1 and a gas igniter having a pre-bracketed fitting;

FIG. 3 is a partially exploded perspective view of the adapter bracket and the gas igniter shown in FIG. 2 which is secured to a support surface;

FIG. 4 is a sectional view taken along line 4-4 in FIG. 3;

FIG. 5 is a partially exploded perspective view of the adapter bracket shown in FIG. 1 securing another gas igniter to a support surface;

FIG. 6 is a sectional view taken along line 6-6 in FIG. 5; and,

FIG. 7 is a top view of the adapter bracket, gas igniter and support surface shown in FIG. 5.

### DESCRIPTION OF A PREFERRED EMBODIMENT

Referring now in greater detail to the drawings wherein the showings are for the purpose of illustrating a preferred embodiment of the invention only, and not for the purpose of limiting the invention, FIGS. 1 and 4 show an adapter bracket 10 for supporting a gas igniter. The adapter bracket having a bracket body 12 which extends in a longitudinal direction 13 between a first end 14 and a second end 16. Body 12 is made from a single piece of shock resistant metal and is preferably made from 430 series stainless steel which is approximately 0.025 inches thick. This construction allows the bracket to absorb shock and to withstand the harsh environment in which the gas igniter can be used.

Body 12 includes a mounting leg 18 on first end 14 which has a width 20 transverse to longitudinal direction 13 and has a longitudinal length 22. It is preferred that width 20 is approximately 0.885 inches. Mounting leg 18 further includes a slot 24 which extends at a slot angle 26 from longitudinal direction 13 which is less than 90°. In this respect, angle 26 is between 70° and 85° and preferably around 80°. The angle of slot 24 allows bracket 10 to be mounted onto a range of support surfaces which will be discussed in greater detail below in connection with the remaining figures. In addition, slot 24 has a slot length 28 extending at slot angle 26 which is preferably approximately 0.475 inches and a slot width 30 which is preferably approximately 0.170 inches. Mounting leg 18 is substantially planar having sides 40 and 42 extending in longitudinal directions 13 and having sides 44 and 46 extending transverse to the longitudinal direction. Body 12 further includes a downwardly extending flange 48 on mounting leg side 44. Flange 48 extends downwardly at a flange angle 50 from a bottom side 52 of mounting leg 18. Flange angle 50 is slightly greater than 90° and is preferably about 100°. Mounting leg 18 further includes a top side 54 opposite to bottom side 52. Flange 48 has the same width as mounting leg 18 and, therefore, extends along all of side 44 of mounting leg 18. Flange 48 includes a flange edge 56 and flange sides 58 and 60 on either side of flange edge 56. Flange 48 has an inner flange surface 62 facing toward mounting leg 18 and an oppositely facing outer flange surface 64. Flange 48 works in connection with the mounting leg to prevent movement of bracket 10 relative to the support surface which will also be discussed in greater detail below.

Body 12 further includes a connecting leg 70 extending longitudinally from side 46 of mounting leg 18 between connecting leg ends 72 and 74. Connecting leg 70 has a longitudinal length 78 and a width 80 wherein width 80 is less than width 20 of mounting leg 18. Further, connecting leg 70 extends upwardly from mounting leg 18 at a connecting leg angle 76. Angle 76 should be between 5° and 20° and is preferably around 10°. By extending upwardly at angle 76, connecting leg suspends the gas igniter above the support structure of the heating apparatus and also absorbs vibrations produced by the heating apparatus thereby shielding the gas igniter from the apparatus vibrations which will be discussed in greater detail below.

Body 12 further includes a clip portion 90 extending longitudinally from end 74 of connecting leg 70. Clip portion 90 includes an upwardly extending segment 92, a circular segment 94, a downwardly extending segment 96, and a lip segment 98. Clip portion 90 has a substantially uniform width 100 which is less than mounting leg width 20 and which is equal to connecting leg width 80. Further, it is preferred that width 100 is approximately 0.600 inches. However, it should be noted that width 100 could be different than connecting leg width 80 without detracting from the invention of this application. Clip portion 90 has a downwardly facing surface 90 and an oppositely facing upward surface 104 which extend continuously along segments 92, 94, 96, and 98.

Upward segment 92 has a bottom end 105 which is joined to connecting leg 70 at connecting leg end 74 and the upward segment is at an upward segment angle 106 from connecting leg 70. Upward segment angle 106 is less than 90° and is preferably about 72°. Upward segment further includes an upward end 110 which is joined to a first end 112 of circular segment 94 which is curved downwardly at a radius of 0.584 inches. In order to interengage with the gas igniter, circular segment 94 extends circumferentially greater than 180° about clip portion axis 114. Preferably, circular segment 94 extends circumferentially 215° about clip axis 114 between first end 112 and a second end 116. By extending 215° about clip axis 114, clip portion 90 can be securely fastened to the outer cylindrical surface of the gas igniter without use of separate fasteners. Lip segment 98 extends from second end 116 of circular segment 94 and together with upward segment 92 define a downwardly facing opening 130 of clip portion 90 which is preferably approximately 458 inches. Lip segment 98 includes a base end 132 which is joined to second end 116 of circular segment 94 and a distal end 134 which represents the end of clip portion 90. Lip segment 98 further produces a ramping effect to orient the outer surface of the gas igniter relative to downward opening 130. In this respect, lip segment 98 is curved away from opening 130 thereby providing a ramp to direct the outer service of the gas igniter into opening 130. While clip portion 90 includes distinguishable segments 92, 94, 96, and 98, these segments are a continuous part of body 12 and act as a unified component. As clip portion 90 is pressed onto the outer surface of the gas igniter, one or more of the segments flex to allow clip portion opening width 136 to expand thereby allowing the gas igniter to pass through opening 130 and be retained in a clip inner portion 138 of clip 90 such that the igniter axis is parallel to clip axis 114.

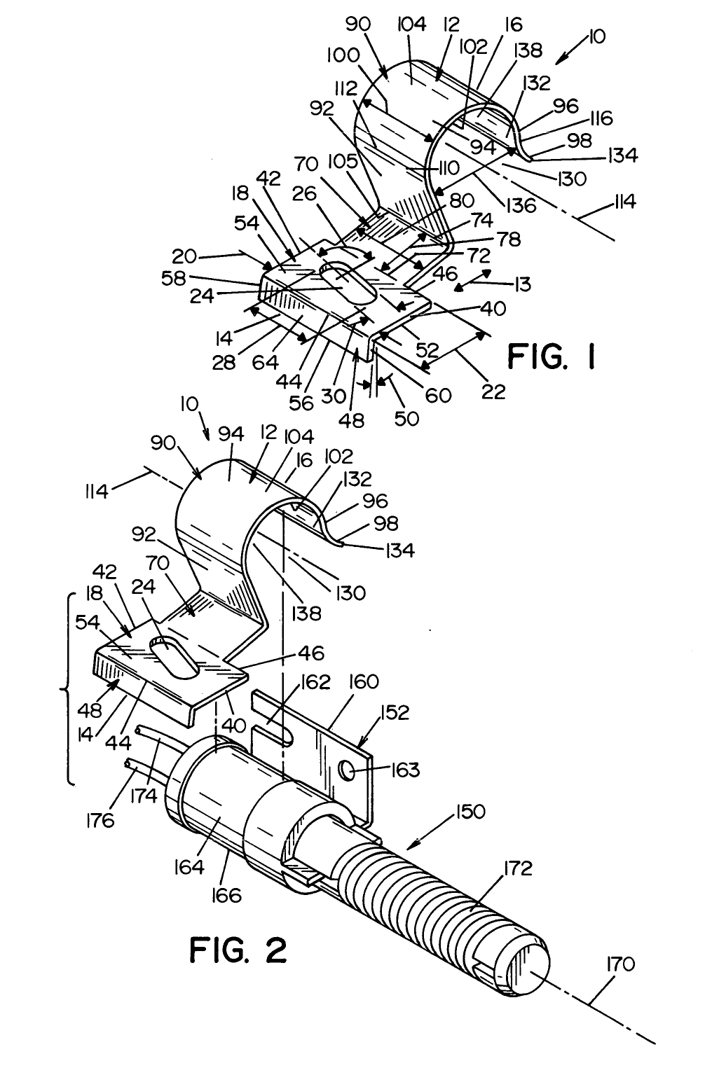

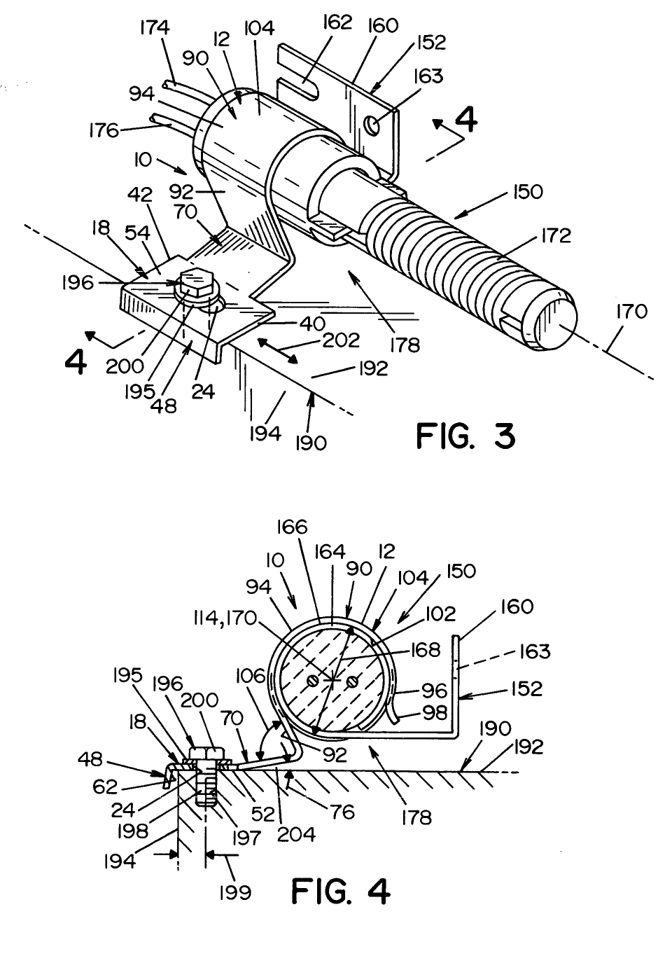

As is shown in FIGS. 2-7, adapter bracket 10 can be used in connection with both a gas igniter 150 which includes a preassembled bracket 152 and a gas igniter 250 which does not include a preassembled bracket. Referring first to FIGS. 2-4, gas igniter 150 is shown which includes bracket 152 have a mounting leg 160 with a slot 162 and a through hole 163. Bracket 152 is configured for a particular mounting application. Bracket 152 further includes a cylindrical sleeve 164 having an outer surface 166 with an outer diameter 168 which is coaxial to a gas igniter axis 170. Gas igniter 150 further includes an igniting element 172 which is electrical and which is supplied power through wires 174 and 176. Adapter bracket 10 is secured to gas igniter 150 by pressing clip portion 90 over outer surface 166 of igniter 150. More particularly, opening width 136 of downwardly facing opening 130 is less than outer diameter 168 of outer surface 166. As a result, outer surface 168 engages lip segment 98 and upward segment 92 as clip portion 90 is being installed on the outer surface. Clip portion 90 is then pressed toward the gas igniter until at least one of segments 92, 94, 96, and/or 98 flexes so that lip segment 98 moves away from upward segment 92 thereby allowing the outer surface 166 to enter inner portion 138 of the clip. It is preferred that the gas igniter is placed on a smooth, flat surface while the clip is secured onto the outer surface to prevent damage to the igniter. Once in place, clip portion extends more than half way about outer surface 166 thereby retaining the outer surface in the clip portion by spring force in an operating position 178. When in operating position 178, igniter axis 170 is parallel to clip axis 114.

Once gas igniter 150 is secured to clip portion 90, adapter bracket 10 can be fastened to a support surface 190 of the heating apparatus with mounting leg 18. Support surface 190 is composed of a horizontal surface 192 and a vertical surface 194. Adapter bracket 10 and gas igniter 150 are fastened to support surface 190 by fastener 196 which extends through slot 24 and which is secured to threaded hole 197 in horizontal surface 192. Fastener 196 is shown to be a threaded fastener having threads 198 and a head 200, however, other fasteners known in the art could be used to secure the bracket and the gas igniter to the support surface. Hole 197 is at a spacing 199 from vertical surface 194 which can vary from one heating apparatus to the next. Furthermore, even if the installer creates hole 197, the placement of the hole may vary. The angular orientation of slot 24 allows bracket 10 to be used in connection with a range of spacings 199 so that bracket 10 can be used in connection with many support surfaces. In this respect, based on the value of spacing 199, bracket 10 can be moved along surface 192 in a direction 202 until a portion of slot 24 is aligned with hole 197 and flange 48 is flush with the support surface. Fastener 196 is then installed through slot 24 in hole 197. The engagement between flange 48 and the support surface prevents rotation of bracket 10 relative to the support surface.

With particular reference to FIG. 4, adapter bracket 10 holds gas igniter 150 above surface 192 in operating position 178 and further provides shock protection for the gas igniter. In this respect, bottom side 52 of mounting leg 18 is juxtaposed surface 192 when adapter bracket is in operation position 178. Therefore, connecting leg 70, which is at an angle from mounting leg 18, extends upwardly from surface 192. The angle in which connecting leg 70 extends upwardly from surface 192 is equivalent to connecting leg angle 76 discussed above. By extending upwardly, a gap 204 is formed between connecting leg 70 and surface 202 wherein bracket 10 can flex about connecting leg end 72. Since bracket body 12 is made from a shock-resistant material, bracket 10 does not transfer vibrations from support surface 190 to igniter 150 thereby increasing the useful life of the igniter. In addition, the angle of connecting leg 70 also provides spacing between gas igniter 150 and surface 192 which prevents the gas igniter from contacting surface 190 and damaging the gas igniter. As stated above, bracket 10 and gas igniter 150 are prevented from rotating about fastener 196 by the engagement between flange 48 the support surface.

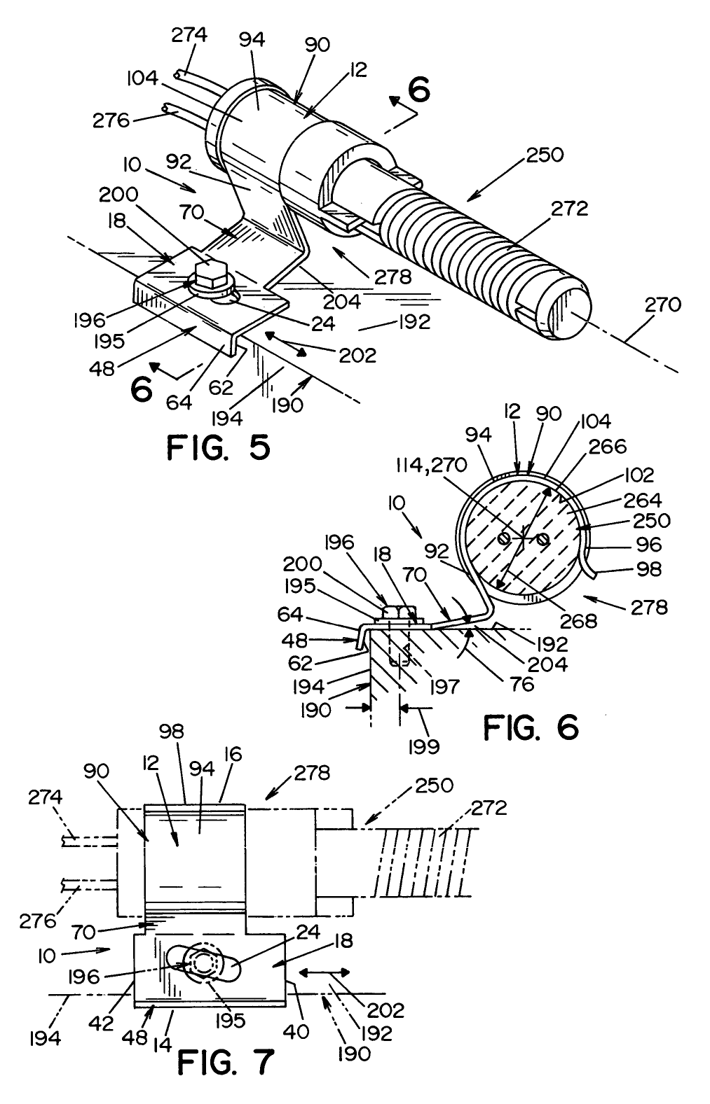

Referring to FIGS. 5-7, gas igniter 250 is shown which does not include a preassembled mounting bracket. Igniter 250 includes a cylindrical outer wall 264 having an outer surface 266 with an outer diameter 268 which is coaxial to a gas igniter axis 270. Gas igniter 250 further includes an igniting element 272 which is electrical and which is supplied power through wires 274 and 276. Adapter bracket 10 is secured to gas igniter 250 in the same fashion as gas igniter 150 discussed above. Namely, the clip portion is pressed over outer surface 266 of igniter 250 until outer surface 266 enters inner portion 138 of the clip. As with the bracketed igniter 150, it is preferred that the gas igniter is placed on a smooth, flat surface while the clip is secured onto the outer surface to prevent damage to the igniter. Once in place, clip portion extends more than half way about outer surface 266 thereby retaining the outer surface of the igniter in the clip portion by spring force in an operating position 278. When in operating position 278, igniter axis 270 is parallel to clip axis 114.

Once gas igniter 250 is secured to clip portion 90, adapter bracket 10 can be fastened to a support surface 190 of the heating apparatus in the same fashion as described above with respect to gas igniter 150. In this respect, adapter bracket 10 and gas igniter 250 are fastened to support surface 190 by fastener 196 which extends through slot 24 and which is secured to threaded hole 197 in horizontal surface 192 and includes a washer 195. The angular orientation of slot 24 allows bracket 10 to be used in connection with a range of spacings 199 so that bracket 10 can be used in connection with many support surfaces. The engagement between flange 48 and the support surface prevents rotation of bracket 10 relative to the support surface. Furthermore, bracket 10 holds gas igniter 250 above surface 192 in operating position 178 and further provides shock protection for the gas igniter as described above with respect to gas igniter 150. In this respect, connecting leg 70, which is at an angle from mounting leg 18, extends upwardly from surface 192 forming a gap 204 between connecting leg 70 and surface 202. This configuration allows bracket 10 to flex about connecting leg end 70. In addition, the angle of connecting leg 70 also provides spacing between gas igniter 250 and surface 192 which prevents the gas igniter from contacting surface 190 and damaging the gas igniter.

While considerable emphasis has been placed on the preferred embodiment of the invention illustrated and described herein, it will be appreciated that other embodiments can be made and that many changes can be made in the preferred embodiment without departing from the principles of the invention. Accordingly, it is to be distinctly understood that the foregoing descriptive matter is to be interpreted merely as illustrative of the invention and not as a limitation.

Having thus described the invention, it is so claimed:

1. A bracket for securing a gas igniter to a support surface, the gas igniter having an axis and including a cylindrical outer surface having an outer diameter, said bracket comprising a bracket body extending in a longitudinal direction between a first end and a second end, said body being curved about a clip axis transverse to said longitudinal direction forming a clip portion near said first end, said clip portion being shaped to receive the cylindrical outer surface of an igniter and having an opening sized smaller than the outer diameter of the igniter outer surface to retain the igniter relative to the bracket such that the igniter axis is parallel to said clip axis, said body further including a slot near said second end extending at a slot angle from said longitudinal direction, said slot angle being between 45 and 90 degrees.

2. The bracket according to claim 1, wherein said slot angle is between 45 and 85 degrees.

3. The bracket according to claim 1, wherein said slot angle is approximately 80 degrees.

4. The bracket according to claim 1, wherein said slot has a slot length extending at said slot angle which is approximately 0.475 inches.

5. The bracket according to claim 1, wherein said bracket body is made from a single strip of metal.

6. The bracket according to claim 5, wherein said strip of metal is approximately 0.025 inches thick.

7. The bracket according to claim 1, wherein said body further includes a central point dividing said body into a first section between said first end and said central point and a second section between said second end and said cental point, said first section including said clip portion and said second section including said slot, said first and second sections having widths transverse to said longitudinal direction and said width of said second section being greater than said width of said first section.

8. The bracket according to claim 1, wherein said body further includes a central point dividing said body into a first section between said first end and said central point and a second section between said second end and said cental point, said first section including said clip portion and said second section including said slot, said second section including a downwardly extending end flange by said second end.

9. The bracket according to claim 8, wherein said end flange is at said second end and is generally perpendicular to said longitudinal direction.

10. The bracket according to claim 1, wherein said body further includes a central point dividing said body into a first section between said first end and said central point and a second section between said second end and said cental point, said first section including said clip portion and said second section including said slot, said body further including a connecting leg between said central point and said clip portion, said support leg supporting said clip portion and the igniter above said support surface.

11. The bracket according to claim 10, wherein said bracket body is made from a single strip of shock resistant metal.

12. The bracket according to claim 11, wherein said first and second sections have widths transverse to said longitudinal direction and said width of said second section is greater than said width of said first section.

13. The bracket according to claim 12, wherein said second section includes a downwardly extending end flange by said second end.

14. The bracket according to claim 1, wherein said clip portion includes a circular segment extending circumferentially about said clip axis greater than 180 degrees and curved lip segment a said first end.

15. The bracket according to claim 14, wherein said circular segment extends circumferentially about said clip axis between 190 and 250.

16. The bracket according to claim 1, wherein said opening width is between 0.300 and 0.625 inches.

17. The bracket according to claim 16, wherein said opening width is approximately 0.458 inches.

18. The bracket according to claim 14, wherein said circular segment has a diameter between 0.450 and 0.700 inches.

19. The bracket according to claim 18, wherein said circular segment has a diameter of approximately 0.584 inches.

20. The bracket according to claim 1, wherein said opening faces said support surface and said body further includes a connecting leg between said slot and said clip portion supporting said clip portion above said support surface.

21. A bracket for securing a gas igniter to a support surface, said igniter having an axis and a cylindrical outer surface having a diameter, said bracket having a mounting leg for attachment to said support surface, an arcuate clip portion for receiving an igniter, said clip portion having an opening smaller than the diameter of the outer surface of the igniter and facing the support surface, and a connecting leg between said mounting leg and said clip portion, said connecting leg supporting said clip portion spaced from the support surface.
